(19) United States
(12) Patent Application Publication
(10) Pub. No.: US 2024/0338684 A1
(43) Pub. Date: Oct. 10, 2024

(54) System and Method for Payment Hardware System Module (HSM) Communications

(71) Applicant: Marvell Asia Pte Ltd, Singapore (SG)

(72) Inventors: Deepanshu Tyagi, Hapur (IN); Dhanalakshmi Saravanan, Bangalore (IN)

(21) Appl. No.: 18/507,920

(22) Filed: Nov. 13, 2023

Related U.S. Application Data
(60) Provisional application No. 63/457,359, filed on Apr. 5, 2023.

(51) Int. Cl. G06Q 20/38

(52) U.S. Cl. CPC G06Q 20/382

(57) ABSTRACT

A system and corresponding method enable payment hardware system module (HSM) communications. The system comprises a multiPayHSM module that transforms an input request, sourced by an application, into a transformed request interpretable by a target payment HSM. The application is integrated, currently, with a current payment HSM that is different from the target payment HSM. The input request is uninterpretable by the target payment HSM. The multiPayHSM module transmits the transformed request to the target payment HSM for processing. The system enables the application, integrated with the different payment HSM, to

[symbol]

### RELATED APPLICATION

This application claims the benefit of U.S. Provisional Application No. 63/457,359, filed on Apr. 5, 2023. The entire teachings of the above application are incorporated herein by reference.

### BACKGROUND

Payment hardware security modules (HSMs) are specialized devices used for key management, encryption, authentication, and other security-related functions for non-limiting examples. Credit card transactions that occur around the world rely on HSMs. As people transition to cashless payment methods, securing their money and ensuring that only authorized people can transact on their behalf becomes increasingly useful and, thus, use of HSMs has increased.

For non-limiting example, an entity providing online payment services can use a payment hardware security module (HSM) to authenticate each transaction before allowing it to proceed. Since the payment HSM may generate all the data that pertains to a transaction, including cryptographic keys, card verification code (CVC) codes, and personal identification numbers (PINs), etc., the payment HSM can also authenticate all the codes for a transaction to identify whether an individual trying to make a payment or access funds is authorized to do so. Such functionality enhances payment security, especially when online fraud and hacking are widespread.

### SUMMARY

According to an example embodiment, a system comprises a multiPayHSM module configured to transform an input request, sourced by an application, into a transformed request interpretable by a target payment hardware system module (HSM). The application is integrated, currently, with a current payment HSM. The current payment HSM is different from the target payment HSM. The input request is uninterpretable by the target payment HSM. The multiPayHSM module is further configured to transmit the transformed request to the target payment HSM for processing.

The target payment HSM and the current payment HSM may be cloud payment hardware system modules (HSMs) in a cloud environment and the system may be located in the cloud environment for non-limiting example.

The multiPayHSM module may be coupled to a plurality of applications. The multiPayHSM module may be coupled to a plurality of payment hardware system modules (HSMs). The plurality of applications may include the application. The plurality of payment HSMs may include the target payment HSM.

The application may lack support for a target application-specific programming interface (API) of the target payment HSM. The application may be configured to communicate with the current payment HSM via a current API of the current payment HSM. The current API may be different from the target API.

The transformed request may be based on the target API of the target payment HSM. The input request may be based on the current API of the current payment HSM.

The multiPayHSM module may be further configured to transform an input response into a transformed response interpretable by the application. The input response may be sourced by the target payment HSM responsive to the processing of the transformed request. The input response may be uninterpretable by the application. The multiPayHSM module may be further configured to transmit the transformed response to the application for processing.

The transformed response may be based on the current API of the current payment HSM. The input response may be based on the target API of the target payment HSM.

The multiPayHSM module may include at least one application-communications converter and at least one HSM-communications converter. An application-communications converter of the at least one application-communications converter may be configured to convert the input request into API data produced in a common (e.g., general, generic) format by decoding the input request based on the current API. A HSM-communications converter of the at least one HSM-communications converter may be configured to produce the transformed request by encoding the API data produced in the common format. The encoding may be based on the target API.

The API data may be API-request data. The HSM-communications converter may be further configured to convert the input response into API-response data produced in the common format by decoding the input response based on the target API. The application-communications converter may be further configured to produce the transformed response by encoding the API-response data produced in the common format. The encoding may be based on the current API.

In a setup phase, the application may be configured to select the current payment HSM from a plurality of payment HSMs coupled to the multiPayHSM module. The current payment HSM may be selected as an integrated payment HSM that is supported by the application, currently, via integration of the application with the current HSM API of the current payment HSM. The application may be further configured to select the target payment HSM from the plurality of payment HSMs. The target payment HSM may be selected for communicating with the application in a runtime phase. The application may lack support for communicating with the target payment HSM selected.

The application may be configured to switch from communicating with the current payment HSM in a runtime phase to communicating with the target payment HSM by selecting, in a setup phase, the current payment HSM and the target payment HSM. In the setup phase, the multiPayHSM module may be further configured to configure converter setup information of the multiPayHSM module to effectuate switching of the communicating.

In the setup phase, the multiPayHSM module may be further configured to configure the converter setup information of the multiPayHSM module based on the current payment HSM selected and the target HSM selected by the application.

In the runtime phase, the multiPayHSM module may be further configured to employ the application-communications converter of the at least one application-communications converter based on the converter setup information configured. The application-communications converter may be configured to convert the input request received from the application into API data produced in a common format by decoding the input request based on the current API. In the runtime phase, the multiPayHSM module may be further configured to employ the HSM-communications converter of the at least one HSM-communications converter based on the converter setup information configured. The HSM-communications converter may be configured to produce the transformed request by encoding the API data in accordance with the target API. The API data may be request-API data and, in the runtime phase, the multiPayHSM module may be further configured to transform an input response into a transformed response interpretable by the application. The input response may be sourced by the target payment HSM responsive to the processing of the transformed request. The input response may be uninterpretable by the application. To transform the input response, the multiPayHSM module may be further configured to employ the HSM-communications converter to convert the input response into response-API data produced in the common format by decoding the input response based on the target API and to employ the application-communications converter to produce the transformed response by encoding the response-API data in accordance with the current API. The multiPayHSM module may be further configured to transmit the transformed response to the application for processing.

The multiPayHSM module may be further configured to transform the input request in a runtime phase and, in an event the application selects, in a setup phase, the current payment HSM and the target payment HSM for communication in the runtime phase, the multiPayHSM module may be further configured to transmit, in the runtime phase, the input request sourced by the application to the current payment HSM, unaltered. The multiPayHSM module may be further configured to transform, in the runtime phase, a first input response into a transformed response interpretable by the application, wherein the first input response is sourced by the target payment HSM responsive to the processing of the transformed request. The multiPayHSM module may be further configured to transmit the transformed response to the application for processing and transmit a second input response, sourced by the current payment HSM responsive to the processing of the input request, to the application, unaltered, for processing.

The system may be a cloud-based system for non-limiting example.

The system may be implemented on an integrated circuit (IC) chip for non-limiting example.

According to another example embodiment, a method comprises transforming an input request, sourced by an application, into a transformed request interpretable by a target payment hardware system module (HSM). The application is integrated, currently, with a current payment HSM. The current payment HSM is different from the target payment HSM. The input request is uninterpretable by the target payment HSM. The method further comprises transmitting the transformed request to the target payment HSM for processing.

Alternative method embodiments parallel those described above in connection with the example system embodiment.

According to another example embodiment, a non-transitory computer-readable medium has encoded thereon a sequence of instructions which, when loaded and executed by at least one processor, causes the at least one processor to transform an input request, sourced by an application, into a transformed request interpretable by a target payment hardware system module (HSM). The application is integrated, currently, with a current payment HSM. The current payment HSM is different from the target payment HSM. The input request is uninterpretable by the target payment HSM. The sequence of instructions further causes the at least one processor to transmit the transformed request to the target payment HSM for processing.

Alternative non-transitory computer-readable medium embodiments parallel those described above in connection with the example system embodiment.

According to yet another example embodiment, an apparatus comprises means for transforming an input request, sourced by an application, into a transformed request interpretable by a target payment hardware system module (HSM). The application is integrated, currently, with a current payment HSM. The current payment HSM is different from the target payment HSM. The input request is uninterpretable by the target payment HSM. The apparatus further comprises means for transmitting the transformed request to the target payment HSM for processing.

Alternative apparatus embodiments parallel those described above in connection with the example system embodiment.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a system.

FIG. 1B is a block diagram of another example embodiment of the system of FIG. 1A.

FIG. 1C is a block diagram of another example embodiment of the system of FIG. 1A.

FIG. 1D is a block diagram of an example embodiment of a multiPayHSM module.

FIG. 2A is a block diagram of an example embodiment of a multiPayHSM module in a setup phase.

FIG. 2B is a block diagram of an example embodiment of the multiPayHSM module of FIG. 2A in a runtime phase.

FIG. 3 is a flow diagram of an example embodiment of a method.

FIG. 4 is a block diagram of an example internal structure of a computer optionally within an embodiment disclosed herein.

### DETAILED DESCRIPTION

A description of example embodiments follows.

Payment systems worldwide have permitted online and offline financial transactions for many decades. Payment systems depend heavily on reliable security of sensitive data which is primarily guided by major credit card brands and country-specific central banks. Understanding the importance of standardization, major card brands collaborated to form the Payment Card Industry Security Standards Council (PCI SSC) to protect the card payment environments by certifying the payment terminals and payment hardware security modules (HSMs).

For online payment transactions, HSMs are used for processing sensitive data. HSMs may be employed in the cloud as a service, which reduces management overhead and simplifies operations. In the cloud, multiple payment hardware security module (HSM) vendors are available and such vendors may offer different features and different computational capabilities. These vendors, referenced interchangeably herein as payment HSM vendors, provide payment application programming interfaces (APIs) to application developers. Such APIs are provided in a respective, vendor-specific format and, thus, switching from one payment HSM vendor to another in the cloud is not seamless. Payment application developers are faced with the effort of adapting their application to interface with a new HSM payment API and perform application integration with the new payment HSM API each time there is a HSM switch, that is, a change from interfacing with a present HSM of one vendor to another HSM of a different vendor.

Conventionally, an existing cloud application is updated while switching from one payment HSM vendor to another. An example embodiment eliminates such updating, thereby avoiding the cost of development effort for the updating and testing, further avoiding a cost to address issues that may result as a function of same, such as errors that may be introduced with each development.

An example embodiment of a system disclosed herein may be based on a payment HSM deployment model that enables an application that is integrated with a first payment HSM, to switch to a second payment HSM without any change to the application. In such a model, a new layer may be introduced to the system, which may be a cloud-based payment HSM system. Such a new layer may be referred to interchangeably herein as a multiPayHSM layer or flexiPayHSM layer, as the system thereof comprises a multiPayHSM module that may also be referred to interchangeably herein as a flexiPayHSM module. The multiPayHSM module may be configured to decode an input request from an application in order to read an input(s) based on an API of the first vendor of a first payment HSM and encode a new request in accordance with an API of a second vendor of a second payment HSM. The first payment HSM may be employed in a present runtime phase and the application may switch from interfacing with the first payment HSM to the second payment HSM in a next runtime phase, seamlessly, that is, without any change to the application.

For example, an application, referred to simply as “App-1,” may be integrated with a HSM-1 API, that is, an API of a first vendor of a first HSM referred to as “HSM-1.” It should be understood that such an API may define a plurality of API functions and, thus, may also referred to in a plural sense, that is, “APIs.” It may be useful for App-1 to switch from interfacing with the first payment HSM (i.e., HSM-1) of the first vendor to interfacing with a second payment HSM (i.e., HSM-2) of a second vendor or a third HSM (i.e., HSM-3) of a third vendor for non-limiting example. It should be understood that a number of payment hardware module systems (HSMs) described herein is for non-limiting example and that such number is not limited to three. In a setup phase of an example embodiment of a system disclosed herein, an application, such as a cloud payment HSM application, may be configured to select a current payment HSM, such as HSM-1, with which the application is integrated, currently, and a target payment HSM, such as HSM-3 for non-limiting example, to which the application is to switch and, thus, communication with.

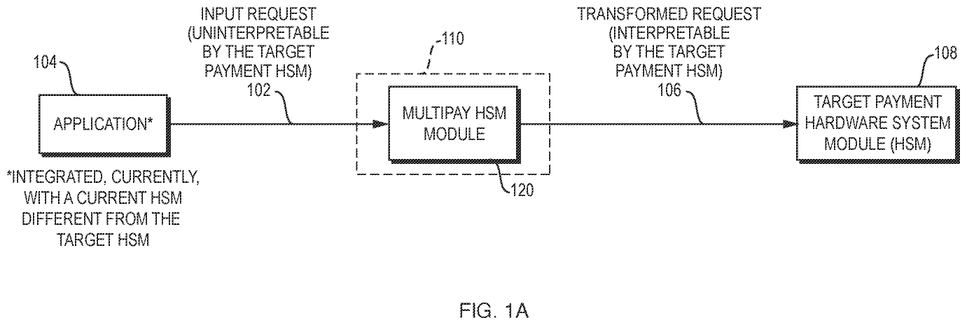

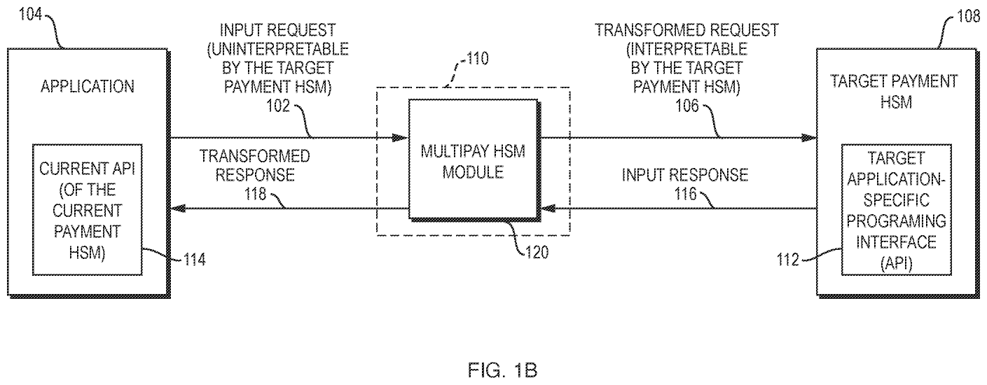

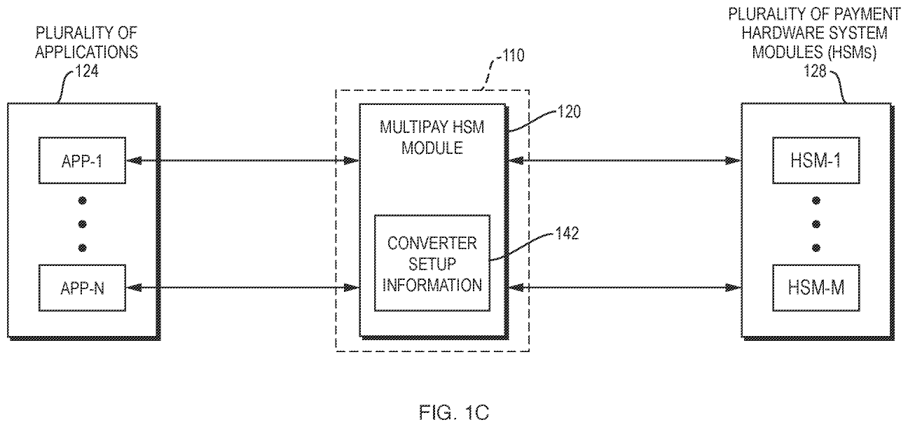

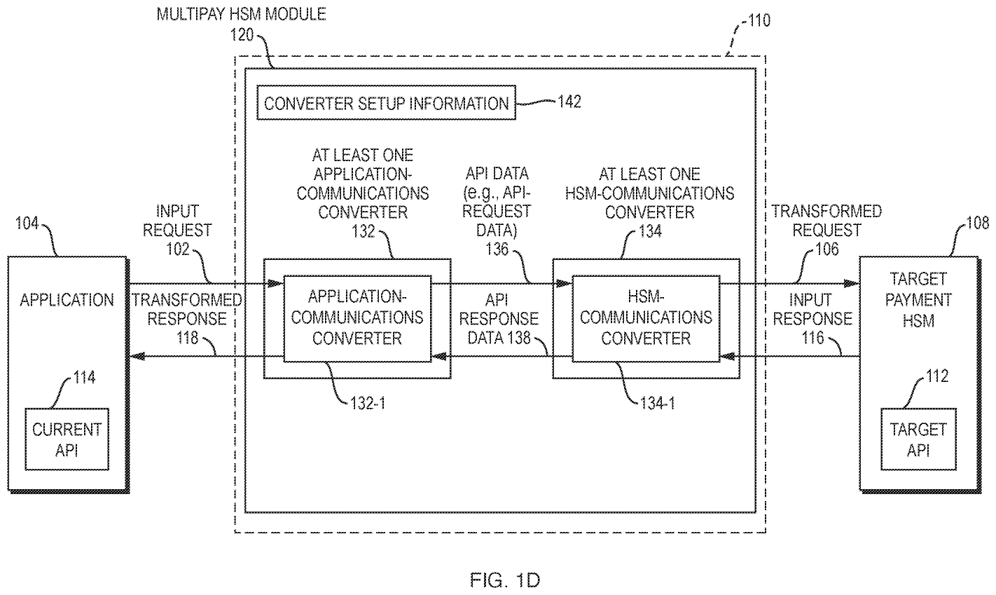

According to an example embodiment, in a runtime (processing) phase, the application may be configured to send an input request, encoded using a current payment HSM API format of HSM-1, to the cloud multiPayHSM module. Such module may, in turn, be configured to decode the input request and encode an input(s) of the input request as per a target HSM API of a target payment HSM, such as HSM-3 for non-limiting example, and pass such an encoded request to the target payment HSM. Following completion of processing the encoded request, the target payment HSM may transmit a response, formatted in accordance with the target API of the target payment HSM, to the multiPayHSM module. The multiPayHSM module may, in turn, decode the response as per the target payment HSM API and encode an input(s) of the response in accordance with the current payment HSM API and pass such an encoded response to the application. By employing a system based on such a model, multiple payment HSMs can be used by an application without any change to the application. This provides the flexibility to the application and users thereof to switch to any supported payment HSM of a cloud environment for non-limiting example, and further enables use of different HSMs, simultaneously, as disclosed further below. An example embodiment of system that enables such flexibility is disclosed below with regard to FIG. 1.

FIG. 1A is a block diagram of an example embodiment of a system 110. The system 110 comprises a multiPayHSM module 120 configured to transform an input request 102, sourced by an application 104, into a transformed request 106 interpretable by a target payment hardware system module (HSM) 108. The application 108 is integrated, currently, with a current payment HSM (not shown). The current payment HSM is different from the target payment HSM 108. The input request 102 is uninterpretable by the target payment HSM 108. The multiPayHSM module 120 is further configured to transmit the transformed request 106 to the target payment HSM 108 for processing.

The application 104 may lack support for a target application-specific programming interface (API) of the target payment HSM 108, such as the target API 112 of the target payment HSM 108 disclosed below with regard to FIG. 1B.

FIG. 1B is a block diagram of another example embodiment of the system 110 of FIG. 1A, disclosed above. With regard to FIG. 1B, the application 104 may lack support for the target API 112. The application 104 may be configured to communicate with the current payment HSM (not shown) via a current API 114 of the current payment HSM. The current API 114 may be different from the target API 112. The transformed request 106 may be based on the target API 112 of the target payment HSM 108. The input request 102 may be based on the current API 114 of the current payment HSM.

The multiPayHSM module 120 may be further configured to transform an input response 116 into a transformed response 118 that is interpretable by the application 104. The input response 116 may be sourced by the target payment HSM 108 responsive to the processing of the transformed request 106. The input response 116 may be uninterpretable by the application 104 because, as disclosed above, the application 104 may lack support for the target API 112. Continuing with reference to FIG. 1B, the multiPayHSM module 120 may be further configured to transmit the transformed response 118 to the application 104 for processing. The transformed response 118 may be based on the current API 114 of the current payment HSM. The input response 116 may be based on the target API 112 of the target payment HSM 108.

The target payment HSM 108 and the current payment HSM may be cloud payment hardware system modules (HSMs) in a cloud environment (not shown) and the system 100 may be located in the cloud environment for non-limiting example. The multiPayHSM module 120 may be coupled to a plurality of applications and a plurality of HSMs, such as disclosed below with regard to FIG. 1C.

FIG. 1C is a block diagram of another example embodiment of the system 110 of FIG. 1A. In the example embodiment of FIG. 1C, the multiPayHSM module 120 of the system 110 is coupled to a plurality of applications 124 and a plurality of payment hardware system modules (HSMs) 128, all of which may be located in a cloud (not shown), according to a non-limiting example. With reference to FIGS. 1A-C, the plurality of applications 124 may include the application 104. The plurality of payment HSMs may include the current HSM (not shown) and the target payment HSM 108.

According to an example embodiment, the multiPayHSM module 120 may include at least one application-communications converter and at least one HSM-communications converter, such as disclosed below with regard to FIG. 1D.

FIG. 1D is a block diagram of an example embodiment of the multiPayHSM module 120, disclosed above. In the example embodiment of FIG. 1D, the multiPayHSM module 120 includes converter setup information 142. The converter setup information 142 may be configured based on configuration information (not shown) that may be received from the application 104. Such configuration information may identify the current payment HSM (not shown) with which the application 104 is integrated, currently. The configuration information may further identify each payment HSM with which the application 104 is to communicate in a runtime phase. The configuration information may identify multiple payment HSMs for communication, enabling the application 104 to communicate with multiple payment HSMs, simultaneously. Such simultaneous communication may be enabled via converters of the multiPayHSM module 120 that may be configured based on the converter setup information 142, as disclosed below.

With reference to FIGS. 1A-D, the multiPayHSM module 120 may include at least one application-communications converter 132 and at least one HSM-communications converter 134. An application-communications converter 132-1 of the at least one application-communications converter 132 may be configured to convert the input request 102 into API data 136 produced in a common (generic, general) format by decoding the input request 102 based on the current API 114. A HSM-communications converter 134-1 of the at least one HSM-communications converter 134 may be configured to produce the transformed request 106 by encoding the API data 136 produced in the common format. The encoding may be based on the target API 112.

With reference to FIGS. 1B and 1D, the API data 136 may be referred to as API-request data. The HSM-communications converter 134-1 may be further configured to convert the input response 116 into API-response data 138 produced in the common format by decoding the input response 116 based on the target API 112. The application-communications converter 132-1 may be further configured to produce the transformed response 118 by encoding the API-response data 138 produced in the common format. The encoding may be based on the current API 114.

With reference to FIGS. 1A-D, in a setup phase, the application 104 may be configured to select the current payment HSM from the plurality of payment HSMs 128 coupled to the multiPayHSM module 120. The current payment HSM may be selected as an integrated payment HSM that is supported by the application 104, currently, via integration of the application 104 with the current HSM API 114 of the current payment HSM. The application 104 may be further configured to select the target payment HSM 108 from the plurality of payment HSMs 128. The target payment HSM 108 may be selected for communicating with the application 104 in a runtime phase. The application 104 may lack support for communicating with the target payment HSM 108 selected, as disclosed above.

Continuing with reference to FIGS. 1A-C, the application 104 may be configured to switch from communicating with the current payment HSM in a runtime phase to communicating with the target payment HSM 108 by selecting, in a setup phase, the current payment HSM and the target payment HSM 108. In the setup phase, the multiPayHSM module 120 may be further configured to configure converter setup information 142 of the multiPayHSM module 120 to effectuate switching of the communicating.

In the setup phase, the multiPayHSM module 120 may be further configured to configure the converter setup information 142 of the multiPayHSM module 110 based on the current payment HSM selected and the target HSM 108 selected by the application 104.

In the runtime phase, the multiPayHSM module 110 may be further configured to employ the application-communications converter 132-1 of the at least one application-communications converter 132 based on the converter setup information 142 configured. The application-communications converter 132-1 may be configured to convert the input request 102 received from the application 104 into the API data 136 that may be produced in the common format by decoding the input request 102 based on the current API 114, as disclosed above.

In the runtime phase, the multiPayHSM module 120 may be further configured to employ the HSM-communications converter 134-1 of the at least one HSM-communications converter 134 based on the converter setup information 142 configured. The HSM-communications converter 134-1 may be configured to produce the transformed request 106 by encoding the API data 136 in accordance with the target API 112, as disclosed above. The API data 136 may be request-API data and, in the runtime phase, the multiPayHSM module 120 may be further configured to transform the input response 116 into the transformed response 118 interpretable by the application 104, as disclosed above.

The input response 116 may be sourced by the target payment HSM 108 responsive to the processing of the transformed request 106. The input response 116 may be uninterpretable by the application. To transform the input response 116, the multiPayHSM module may be further configured to employ the HSM-communications converter 134-1 in the runtime phase to convert the input response 116 into the response-API data 138 produced in the common format by decoding the input response 116 based on the target API 112 and to employ the application-communications converter 132-1 in the runtime phase to produce the transformed response 118 by encoding the response-API data 138 in accordance with the current API 114. The multiPayHSM module 120 may be further configured to transmit the transformed response 118 to the application 104 in the runtime phase for processing.

The input request 102 may be a first input request. The multiPayHSM module 120 may be further configured to transform the first input request in a present runtime phase. In an event the application 104 selects, in a setup phase following the present runtime phase, the current payment HSM for communication in a next runtime phase, the multiPayHSM module 120 may be further configured to transmit, in the next runtime phase, a second input request (not shown) sourced by the application 104, to the current payment HSM. The second input request may be transmitted, unaltered, to the current payment HSM for processing. The next runtime phase may follow the setup phase. In the next runtime phase, the multiPayHSM module 120 may be further configured to transmit a second input response (not shown), sourced by the current payment HSM responsive to the processing of the second input request, to the application 104, unaltered, for processing.

The multiPayHSM module 120 may be further configured to transform the input request 102 in a runtime phase and, in an event the application 104 selects, in a setup phase, the current payment HSM and the target payment HSM 108 for communication in the runtime phase, the multiPayHSM module 120 may be further configured to transmit, in the runtime phase, the input request 102 sourced by the application 104, to the current payment HSM, unaltered. The multiPayHSM module 120 may be further configured to transform, in the runtime phase, a first input response, that is, the input response 116, into the transformed response 118 interpretable by the application 104, wherein the first input response is sourced by the target payment HSM 108 responsive to the processing of the transformed request 106. The multiPayHSM module 120 may be further configured to transmit the transformed response 118 to the application for processing and transmit a second input response (not shown), sourced by the current payment HSM responsive to the processing of the input request 102, to the application 104, unaltered, for processing.

The system 100 may be a cloud-based system for non-limiting example. The system 100 may be implemented on an integrated circuit (IC) chip for non-limiting example.

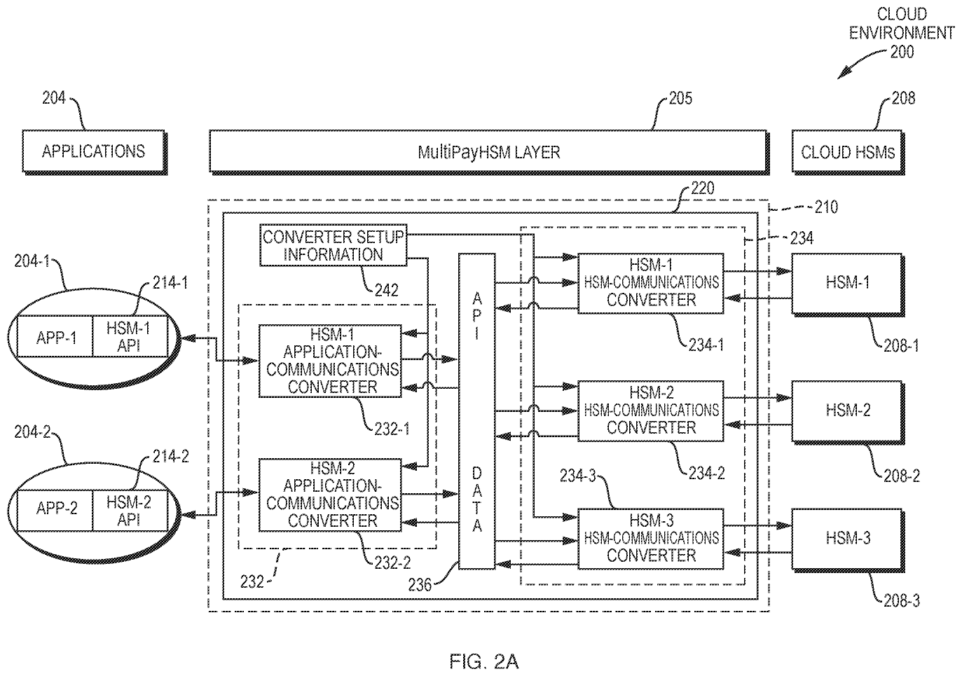

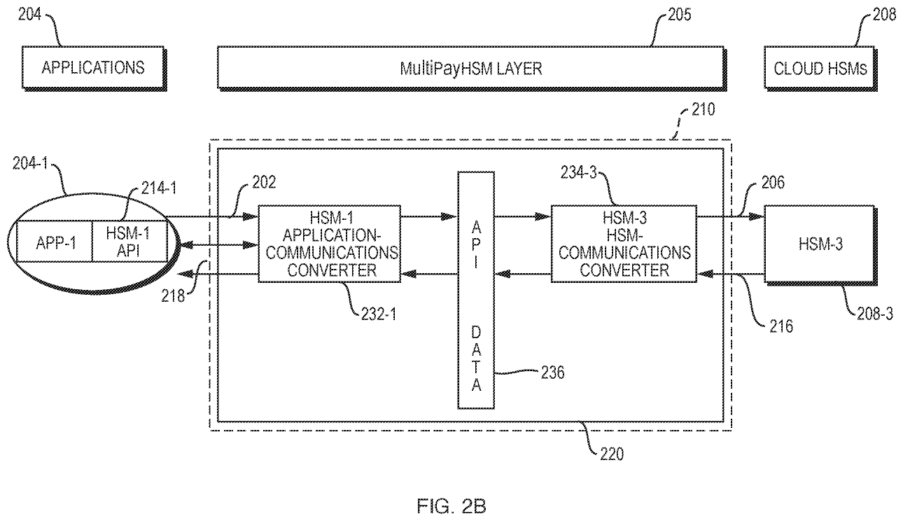

FIG. 2A is a block diagram of an example embodiment of a multiPayHSM module 220 in a setup phase. In the example embodiment, a cloud environment 200 includes applications 204, a system 210 comprising a multiPayHSM module 220, and cloud HSMs 208. A layer of the cloud environment 200 that includes the system 210 comprising the multiPayHSM module 220 may be referred to as a multiPayHSM layer 205.

The cloud HSMs 208 may be payment HSMs including a first payment HSM 208-1, a second payment HSM 208-2, and a third payment HSM 208-3 referred to as “HSM-1,” “HSM-2,” and “HSM-3,” respectively. It should be understood that a number of the payment HSMs shown is for non-limiting example. The applications 204 include a first application 204-1 that is integrated, currently, with a HSM-1 API 214-1 of HSM-1 and a second application 204-2 that is integrated, currently, with a HSM-2 API 214-2 of HSM-2. As such, the HSM-1 API 214-1 and HSM-2 API 214-2 may be referred to as respective current APIs of the first application 204-1 and second application 204-2. The first application 204-1 and second application 204-2 may be referred to interchangeably as “App-1” and “App-2,” respectively. The system 210 comprising the multiPayHSM module 220 may be employed as the system 110 comprising the multiPayHSM module 120 disclosed above with regard to FIGS. 1A-D.

Continuing with reference to FIG. 2A, the multiPayHSM module 220 includes at least one application-communications converter 232 and at least one HSM-communications converter 234. A first application-communications converter of the at least one application-communications converter 232, namely the HSM-1 application-communications converter 232-1, may be configured to convert an input request (not shown) into API data of the API data 236. Such API data may be produced in a common (generic, general) format by decoding the input request based on a respective API of a payment HSM of the cloud HSMs, namely the HSM-1 API 214-1 of HSM-1 in the non-limiting example embodiment. The HSM-1 application-communications converter 232-1 may be further configured to produce a response to such input request by encoding API data of the API data 236 in accordance with the respective API, namely the HSM-1 API 214-1 of HSM-1 in the non-limiting example embodiment.

Similarly, a second application-communications converter of the at least one application-communications converter 232, namely the HSM-2 application-communications converter 232-2, may be configured to convert an input request (not shown) into API data of the API data 236. Such API data may be produced in the common format by decoding such input request based on a respective API of a payment HSM of the cloud HSMs, namely the HSM-2 API 214-2 of HSM-2 in the non-limiting example embodiment. The HSM-2 application-communications converter 232-2 may be further configured to produce a response to such input request by encoding API data of the API data 236 in accordance with the respective API, namely the HSM-2 API 214-2 of HSM-2 in the non-limiting example embodiment.

A first HSM-communications converter of the at least one HSM-communications converter 234, namely the HSM-1 HSM-communications converter 234-1 may be configured to produce a transformed request (not shown) by encoding API data of the API data 136 produced in the common format. The encoding may be based on a respective API of a payment HSM of the cloud HSMs, namely the HSM-1 API 214-1 of HSM-1 in the non-limiting example embodiment. The HSM-1 HSM-communications converter 234-1 may be further configured to convert an input response (not shown) received from HSM-1 into API data of the API data 236 produced in the common format by decoding an input response from HSM-1 based on the HSM-1 API 214-2 of HSM-1.

Similarly, a second HSM-communications converter of the at least one HSM-communications converter 234, namely the HSM-2 HSM-communications converter 234-2 may be configured to produce a transformed request (not shown) by encoding API data of the API data 236 produced in the common format. The encoding may be based on a respective API of a payment HSM of the cloud HSMs, namely the HSM-2 API 214-2 of HSM-2 in the non-limiting example embodiment. The HSM-2 HSM-communications converter 234-2 may be further configured to convert an input response (not shown) received from HSM-2 into API data of the API data 236 produced in the common format by decoding an input response from HSM-2 based on the HSM-2 API 214-2 of HSM-2.

Likewise, a third HSM-communications converter of the at least one HSM-communications converter 234, namely the HSM-3 HSM-communications converter 234-3 may be configured to produce a transformed request (not shown) by encoding API data of the API data 236 produced in the common format. The encoding may be based on a respective API of a payment HSM of the cloud HSMs, namely a HSM API (not shown) of HSM-3 in the non-limiting example embodiment. The HSM-3 HSM-communications converter 234-3 may be further configured to convert an input response (not shown) received from HSM-3 into API data of the API data 236 produced in the common format by decoding an input response from HSM-3 based on the HSM API of HSM-3.

A non-limiting example use case of the system 210 includes generating a personal identification number (PIN) (not shown) using a first API of a first vendor (not shown) and a payment HSM of a second vendor (not shown), wherein the first and second vendors are different vendors. Such use case may be implemented by configuring the system 210 in a setup phase. For example, the HSM-1 API 214-1 may be the first API of the first vendor. The first vendor may be a vendor of HSM-1. HSM-3 may be the payment HSM of the second vendor. HSM-3 may be referred to as a target payment HSM targeted for performing an operation, such as PIN generation in the non-limiting example embodiment.

An application, such as App-1, may be bound (integrated) with APIs of the first vendor, namely the HSM-1 API 214-1; however, it may be useful for App-1 to perform the generate PIN operation on the payment HSM of the second vendor, that is, HSM-3. During the setup phase, App-1 may be configured to select the HSM-1 application-communications converter 232-1 and the HSM-3 HSM-communications converter. Such selection may be stored in the converter setup information 242 for use in a runtime (processing) phase as disclosed below with regard to FIG. 2B.

FIG. 2B is a block diagram of an example embodiment of the multiPayHSM module 220 of FIG. 2A in the runtime (processing) phase. FIG. 2B is a simplified version of FIG. 2A for describing the processing phase. It should be understood, however, that all of the elements of FIG. 2A are present in FIG. 2B.

With reference to FIGS. 2A and 2B, in the processing phase, the application, namely App-1, composes an input request 202 by using, for non-limiting example, a Generate PIN API of the HSM-1 API 214-1 and transmits the input request 202 to the multiPayHSM layer 205 of the cloud environment 200. In the multiPayHSM module 220 of the MultiPayHSM layer 205, the HSM-1 application-communications converter 232-1 is employed per the converter setup information 242. The HSM-1 application-communications converter 232-1 accepts the input request 202 and decodes input(s) thereof into API data of the API 236 in a common format. Such API data is, in turn, passed along as input to the HSM-3 HSM-communications converter 234-3 per the converter setup information 242.

The HSM-3 HSM-communications converter 234-3, in turn, encodes such input into an API format as per the HSM-3 API (e.g., target API, not shown) of HSM-3 (e.g., target payment HSM). Such encoded input may be referred to as a transformed input request 206 that is transmitted to the HSM-3 to perform the Generate PIN operation. The HSM-3 may perform a computation(s) to generate a PIN per the transformed request 206 and return an input response 216 to the HSM-3 HSM-communications converter 234-3 which, in turn, decodes the input response 216 to produce input(s) thereof as API data of the API data 236 that is in a common format. Such API data in the common format may be passed to the HSM-1 application-communications converter 232-1 which, in turn, encodes same based on the HSM-1 API 214-1 to produce a transformed response 118 that is transmitted to the application, that is App-1 in the non-limiting example embodiment, which is in the expected API format of the HSM-1 vendor's Generate PIN API.

It should be understood that the Generate PIN API disclosed above is for non-limiting example and that an API of a payment HSM disclosed herein is not limited to same.

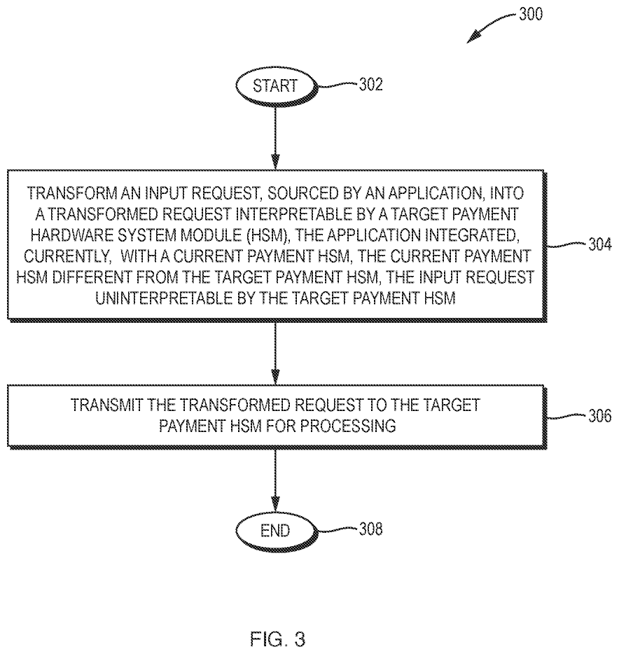

FIG. 3 is a flow diagram of an example embodiment of a method 300. The method begins (302) and comprises transforming an input request, sourced by an application, into a transformed request interpretable by a target payment hardware system module (HSM) (304). The application is integrated, currently, with a current payment HSM. The current payment HSM is different from the target payment HSM. The input request is uninterpretable by the target payment HSM. The method further comprises transmitting the transformed request to the target payment HSM for processing (306), and the method thereafter ends (308) in the example embodiment.

The transforming may be performed by a multiPayHSM module. The target payment HSM and the current payment HSM may be cloud payment hardware system modules (HSMs) in a cloud environment. The multiPayHSM module may be located in the cloud environment. A layer of the cloud environment that includes a system with the multiPayHSM module may be referred to herein as a multiPayHSM layer.

The method may further comprise transforming an input response into a transformed response interpretable by the application. The input response may be sourced by the target payment HSM responsive to the processing of the transformed request. The input response may be uninterpretable by the application. The method may further comprise transmitting the transformed response to the application for processing. The transformed response may be based on a current API of the current payment HSM. The input response may be based on a target API of the target payment HSM. The current API may be different from the target API.

The input request may be based on the current API of the current payment HSM. The transformed request may be based on the target API of the target payment HSM. Transforming the input request may include converting the input request into API data produced in a common format by decoding the input request based on the current API. The transforming may further include producing the transformed request by encoding the API data produced in the common format. The encoding may be based on the target API. The current API may be different from the target API.

The API data may be request-API data. Transforming the input response may include converting the input response into response-API data produced in the common format by decoding the input response based on the target API. Transforming the input response may further include producing the transformed response by encoding the response-API data produced in the common format and transmitting the transformed response to the application for processing. The encoding may be based on the current API.

The method may further comprise, in a setup phase, selecting, by the application, the current payment HSM from a plurality of payment HSMs. The current payment HSM may be selected as an integrated payment HSM that is supported by the application, currently, via integration of the application with the current HSM API of the current payment HSM. The method may further comprise, in the setup phase, selecting, by the application, the target payment HSM from a plurality of payment HSMs. The target payment HSM may be selected for communicating with the application in a runtime phase. The application may lack support for communicating with the target payment HSM selected.

The method may further comprise switching from communicating with the current payment HSM in the runtime phase to communicating with the target payment HSM. The switching may include selecting, in the setup phase, the current payment HSM and the target payment HSM and, in the setup phase, configuring converter setup information of the multiPayHSM module to effectuate the switching. Configuring the converter setup information of the multiPayHSM module may be based on the current payment HSM selected and the target HSM selected by the application.

The input request may be a first input request. The method may further comprise transforming the first input request in a present runtime phase. In an event the application selects, in a setup phase following the present runtime phase, the current payment HSM for communication in a next runtime phase, the method may further comprise transmitting, in the next runtime phase, a second input request sourced by the application to the current payment HSM. The second input request may be transmitted, unaltered, to the current payment HSM for processing. The next runtime phase may follow the setup phase. The method may further comprise transmitting, in the next runtime phase, a second input response, sourced by the current payment HSM responsive to the processing of the second input request, to the application, unaltered, for processing.

The method may further comprise transforming the input request in the runtime phase and wherein, in an event the application selects, in the setup phase, the current payment HSM and the target payment HSM for communication in the runtime phase, the method may further comprise transmitting, in the runtime phase, the input request sourced by the application to the current payment HSM, unaltered, transforming in the runtime phase, a first input response into a transformed response interpretable by the application. The first input response may be sourced by the target payment HSM responsive to the processing of the transformed request. The method may further comprise transmitting the transformed response to the application for processing; and transmitting a second input response, sourced by the current payment HSM responsive to the processing of the input request, to the application, unaltered, for processing.

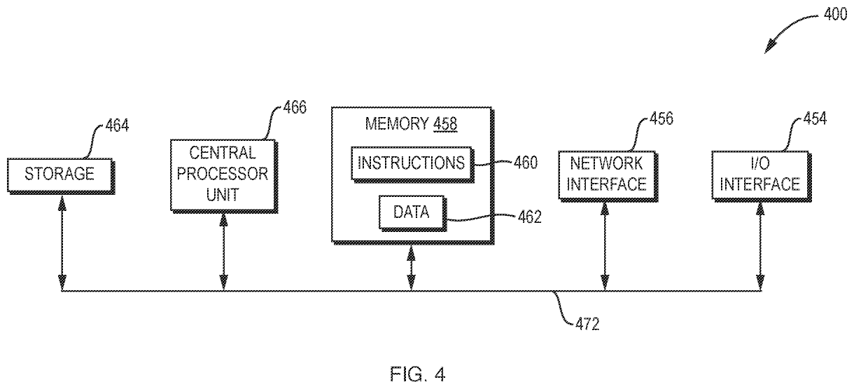

FIG. 4 is a block diagram of an example of the internal structure of a computer 400 in which various embodiments of the present disclosure may be implemented. The computer 400 contains a system bus 452, where a bus is a set of hardware lines used for data transfer among the components of a computer or digital processing system. The system bus 452 is essentially a shared conduit that connects different elements of a computer system (e.g., processor, disk storage, memory, input/output ports, network ports, etc.) that enables the transfer of information between the elements. Coupled to the system bus 452 is an I/O device interface 454 for connecting various input and output devices (e.g., keyboard, mouse, display monitors, printers, speakers, etc.) to the computer 400. A network interface 456 allows the computer 400 to connect to various other devices attached to a network (e.g., global computer network, wide area network, local area network, etc.). Memory 458 provides volatile or non-volatile storage for computer software instructions 460 and data 462 that may be used to implement embodiments (e.g., method 400) of the present disclosure, where the volatile and non-volatile memories are examples of non-transitory media. Disk storage 464 provides non-volatile storage for computer software instructions 460 and data 462 that may be used to implement embodiments (e.g., method 400) of the present disclosure. A central processor unit 466 is also coupled to the system bus 452 and provides for the execution of computer instructions.

As used herein, the term “interface,” “module,” or “layer” may refer to any hardware, software, firmware, electronic control component, processing logic, and/or processor device, individually or in any combination, including without limitation: an application-specific integrated circuit (ASIC), a field-programmable gate array (FPGA), an electronic circuit, a processor and memory that executes one or more software or firmware programs, and/or other suitable components that provide the described functionality. According to a non-limiting example embodiment, an “interface,” “module,” or “layer” may include at least one processor and at least one memory with computer code instructions stored thereon. The at least one processor and the at least one memory, with computer code instructions, may be configured to cause the interface, module, or layer to perform its respective configured functions.

Example embodiments disclosed herein may be configured using a computer program product; for example, controls may be programmed in software for implementing example embodiments. Further example embodiments may include a non-transitory, computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 5, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A system comprising:
a multiPayHSM module configured to transform an input request, sourced by an application, into a transformed request interpretable by a target payment hardware system module (HSM), the application integrated, currently, with a current payment HSM, the current payment HSM different from the target payment HSM, the input request uninterpretable by the target payment HSM,
the multiPayHSM module further configured to transmit the transformed request to the target payment HSM for processing.

2. The system of claim 1, wherein the target payment HSM and the current payment HSM are cloud payment hardware system modules (HSMs) in a cloud environment and wherein the system is located in the cloud environment.

3. The system of claim 1, wherein the multiPayHSM module is coupled to a plurality of applications, wherein the multiPayHSM module is coupled to a plurality of payment hardware system modules (HSMs), wherein the plurality of applications includes the application, and wherein the plurality of payment HSMs includes the target payment HSM.

4. The system of claim 1, wherein the application lacks support for a target application-specific programming interface (API) of the target payment HSM, wherein the application is configured to communicate with the current payment HSM via a current API of the current payment HSM, and wherein the current API is different from the target API.

5. The system of claim 1, wherein the transformed request is based on a target API of the target payment HSM, wherein the input request is based on a current API of the current payment HSM, and wherein the current API is different from the target API.

6. The system of claim 1, wherein the multiPayHSM module is further configured to:
transform an input response into a transformed response interpretable by the application, wherein the input response is sourced by the target payment HSM responsive to the processing of the transformed request, and wherein the input response is uninterpretable by the application; and
transmit the transformed response to the application for processing.

7. The system of claim 6, wherein the transformed response is based on a current API of the current payment HSM, wherein the input response is based on a target API of the target payment HSM, and wherein the current API is different from the target API.

8. The system of claim 1, wherein the input request is based on a current API of the current payment HSM, wherein the transformed request is based on a target API of the target payment HSM, wherein the multiPayHSM module includes at least one application-communications converter and at least one HSM-communications converter, and wherein:
an application-communications converter of the at least one application-communications converter is configured to convert the input request into API data produced in a common format by decoding the input request based on the current API; and
a payment-HSM-communications converter of the at least one payment-HSM-communications converter is configured to produce the transformed request by encoding the API data produced in the common format, wherein the encoding is based on the target API, and wherein the current API is different from the target API.

9. The system of claim 8, wherein the API data is API-request data, wherein the multiPayHSM module is further configured to transform an input response into a transformed response interpretable by the application, wherein the input response is sourced by the target payment HSM responsive to the processing of the transformed request, wherein the input response is uninterpretable by the application, wherein the multiPayHSM module is further configured to transmit the transformed response to the application for processing, and wherein:
the HSM-communications converter is further configured to convert the input response into API-response data produced in the common format by decoding the input response based on the target API; and
the application-communications converter is further configured to produce the transformed response by encoding the API-response data produced in the common format, wherein the encoding is based on the current API.

10. The system of claim 1, wherein, in a setup phase, the application is configured to:
select the current payment HSM from a plurality of payment HSMs coupled to the multiPayHSM module, the current payment HSM selected as an integrated payment HSM that is supported by the application, currently, via integration of the application with a current HSM API of the current payment HSM; and
select the target payment HSM from the plurality of payment HSMs, the target payment HSM selected for communicating with the application in a runtime phase, wherein the application lacks support for communicating with the target payment HSM selected.

11. The system of claim 1, wherein the application is configured to switch from communicating with the current payment HSM in a runtime phase to communicating with the target payment HSM by selecting, in a setup phase, the current payment HSM and the target payment HSM and wherein, in the setup phase, the multiPayHSM module is further configured to configure converter setup information of the multiPayHSM module to effectuate switching of the communicating.

12. The system of claim 1, wherein:
in a setup phase of the system, the application is further configured to select the current payment HSM and the target payment HSM; and
in the setup phase, the multiPayHSM module is further configured to configure converter setup information of the multiPayHSM module based on the current payment HSM selected and the target HSM selected by the application.

13. The system of claim 12, wherein the input request is based on a current API of the current payment HSM, wherein the transformed request is based on a target API of the target payment HSM, wherein the multiPayHSM module includes at least one application-communications converter and at least one HSM-communications converter, and wherein, in a runtime phase, the multiPayHSM module is further configured to:
employ an application-communications converter of the at least one application-communications converter based on the converter setup information configured, wherein the application-communications converter is configured to convert the input request received from the application into API data produced in a common format by decoding the input request based on the current API; and
employ a HSM-communications converter of the at least one HSM-communications converter based on the converter setup information configured, wherein the HSM-communications converter is configured to produce the transformed request by encoding the API data in accordance with the target API, and wherein the current API is different from the target API.

14. The system of claim 13, wherein the API data is request-API data and wherein, in the runtime phase, the multiPayHSM module is further configured to:
transform an input response into a transformed response interpretable by the application, wherein the input response is sourced by the target payment HSM responsive to the processing of the transformed request, wherein the input response is uninterpretable by the application, and wherein, to transform the input response, the multiPayHSM module is further configured to:
employ the HSM-communications converter to convert the input response into response-API data produced in the common format by decoding the input response based on the target API; and
employ the application-communications converter to produce the transformed response by encoding the response-API data in accordance with the current API; and
transmit the transformed response to the application for processing.

15. The system of claim 1, wherein the multiPayHSM module is further configured to transform the input request in a runtime phase and wherein, in an event the application selects, in a setup phase, the current payment HSM and the target payment HSM for communication in the runtime phase, the multiPayHSM module is further configured to:
transmit, in the runtime phase, the input request sourced by the application to the current payment HSM, unaltered.

16. The system of claim 15, wherein the multiPayHSM module is further configured to:
transform, in the runtime phase, a first input response into a transformed response interpretable by the application, wherein the first input response is sourced by the target payment HSM responsive to the processing of the transformed request;
transmit the transformed response to the application for processing; and
transmit a second input response, sourced by the current payment HSM responsive to the processing of the input request, to the application, unaltered, for processing.

17. The system of claim 1, wherein the system is a cloud-based system.

18. The system of claim 1, wherein the system is implemented on an integrated circuit (IC) chip.

19. A method comprising:
transforming an input request, sourced by an application, into a transformed request interpretable by a target payment hardware system module (HSM), the application integrated, currently, with a current payment HSM, the current payment HSM different from the target payment HSM, the input request uninterpretable by the target payment HSM; and
transmitting the transformed request to the target payment HSM for processing.

20. The method of claim 19, wherein the transforming is performed by a multiPayHSM module, wherein the target payment HSM and the current payment HSM are cloud payment hardware system modules (HSMs) in a cloud environment, and wherein the multiPayHSM module is located in the cloud environment.

21. The method of claim 19, wherein the transforming is performed by a multiPayHSM module coupled to a plurality of applications and coupled to a plurality of payment hardware system modules (HSMs), wherein the plurality of applications includes the application, and wherein the plurality of payment HSMs includes the target payment HSM.

22. The method of claim 19, wherein the application lacks support for a target application-specific programming interface (API) of the target HSM, wherein the application includes support for communicating with the current payment HSM via a current API of the current payment HSM, and wherein the current API is different from the target API.

23. The method of claim 19, wherein the transformed request is based on a target API of the target payment HSM, wherein the input request is based on a current API of the current payment HSM, and wherein the current API is different from the target API.

24. The method of claim 19, further comprising:
transforming an input response into a transformed response interpretable by the application, wherein the input response is sourced by the target payment HSM responsive to the processing of the transformed request, and wherein the input response is uninterpretable by the application; and
transmitting the transformed response to the application for processing.

25. The method of claim 24, wherein the transformed response is based on a current API of the current payment HSM, wherein the input response is based on a target API of the target payment HSM, and wherein the current API is different from the target API.

26. The method of claim 19, wherein the input request is based on a current API of the current payment HSM, wherein the transformed request is based on a target API of the target payment HSM, and wherein transforming the input request includes:
converting the input request into API data produced in a common format by decoding the input request based on the current API; and
producing the transformed request by encoding the API data produced in the common format, wherein the encoding is based on the target API, and wherein the current API is different from the target API.

27. The method of claim 26, wherein the API data is request-API data and wherein the method further comprises:
receiving an input response sourced by the target payment HSM responsive to the processing of the transformed request, and wherein the input response is uninterpretable by the application;
transforming the input response received into a transformed response interpretable by the application, wherein transforming the input response includes:
converting the input response into response-API data produced in the common format by decoding the input response based on the target API; and
producing the transformed response by encoding the response-API data produced in the common format, wherein the encoding is based on the current API; and
transmitting the transformed response to the application for processing.

28. The method of claim 19, further comprising, in a setup phase:
selecting, by the application, the current payment HSM from a plurality of payment HSMs, the current payment HSM selected as an integrated payment HSM that is supported by the application, currently, via integration of the application with a current HSM API of the current payment HSM; and
selecting, by the application, the target payment HSM from the plurality of payment HSMs, the target payment HSM selected for communicating with the application in a runtime phase, wherein the application lacks support for communicating with the target payment HSM selected.

29. The method of claim 19, further comprising, switching from communicating with the current payment HSM in a runtime phase to communicating with the target payment HSM, the switching including selecting, in a setup phase, the current payment HSM and the target payment HSM and, in the setup phase, configuring converter setup information of the multiPayHSM module to effectuate the switching.

30. The method of claim 19, further comprising:
in a setup phase of the system, selecting, by the application, the current payment HSM and the target payment HSM; and
in the setup phase, configuring, by a multiPayHSM module, converter setup information of the multiPayHSM module based on the current payment HSM selected and the target HSM selected by the application.

31. The method of claim 30, wherein the input request is based on a current API of the current payment HSM, wherein the transformed request is based on a target API of the target payment HSM, and wherein the transforming includes, in a runtime phase:
converting the input request received from the application into API data produced in a common format by decoding the input request based on the current API; and
producing the transformed request by encoding the API data in accordance with the target API, wherein the current API is different from the target API.

32. The method of claim 31, wherein the API data is request-API data and wherein the method further comprises, in the runtime phase:
receiving an input response sourced by the target payment HSM responsive to the processing of the transformed request, wherein the input response is uninterpretable by the application;
transforming the input response received into a transformed response interpretable by the application, wherein transforming the input response received includes:
converting the input response received into response-API data produced in the common format by decoding the input response based on the target API; and
producing the transformed response by encoding the response-API data in accordance with the current API; and
transmitting the transformed response to the application for processing.

33. The method of claim 19, further comprising transforming the input request in a runtime phase and wherein, in an event the application selects, in a setup phase, the current payment HSM and the target payment HSM for communication in the runtime phase, the method further comprises:
transmitting, in the runtime phase, the input request sourced by the application to the current payment HSM, unaltered.

34. The method of claim 33, further comprising:
transforming in the runtime phase, a first input response into a transformed response interpretable by the application, wherein the first input response is sourced by the target payment HSM responsive to the processing of the transformed request;
transmitting the transformed response to the application for processing; and
transmitting a second input response, sourced by the current payment HSM responsive to the processing of the input request, to the application, unaltered, for processing.

35. The method of claim 19, further comprising performing the method via a cloud-based system.

36. The method of claim 19, further comprising implementing the method via an integrated circuit (IC) chip.

37. A non-transitory computer-readable medium having encoded thereon a sequence of instructions which, when loaded and executed by at least one processor, causes the at least one processor to:
transform an input request, sourced by an application, into a transformed request interpretable by a target payment hardware system module (HSM), the application integrated, currently, with a current payment HSM, the current payment HSM different from the target payment HSM, the input request uninterpretable by the target payment HSM; and
transmit the transformed request to the target payment HSM for processing.

38. An apparatus comprising:
means for transforming an input request, sourced by an application, into a transformed request interpretable by a target payment hardware system module (HSM), the application integrated, currently, with a current payment HSM, the current payment HSM different from the target payment HSM, the input request uninterpretable by the target payment HSM; and
means for transmitting the transformed request to the target payment HSM for processing.
